(19) United States
(12) Patent Application Publication
(10) Pub. No.: US 2015/0200788 A1
(43) Pub. Date: Jul. 16, 2015

(54) AUTOMATED DEVICE IDENTIFICATION

(71) Applicants: Christopher Todd Thomas, San Diego, CA (US); Jun Ye, San Diego, CA (US)

(72) Inventors: Christopher Todd Thomas, San Diego, CA (US); Jun Ye, San Diego, CA (US)

(21) Appl. No.: 14/092,766

(22) Filed: Nov. 27, 2013

(51) Int. Cl. H04L 12/28; H04W 8/22; H04B 10/116; H04M 1/725

(52) U.S. Cl. CPC H04L 12/2816; H04M 1/72533; H04W 8/22; H04B 10/116; H04L 2012/2841

(57) ABSTRACT

Various techniques are provided to facilitate the identification of devices, such as smart light bulbs, ceiling fans, security systems, garage doors, and other devices whose functions may be automated or controlled remotely. Identification is done through visible light using existing light sources on target devices and existing image sensors on control devices. In one example, a user may point the camera sensor on their mobile phone at a smart light bulb. This light bulb is turning on and off faster than the human eye can detect, and it is sending a coded message that can be received and decoded by the camera sensor on the mobile phone. The light bulb is identified by the mobile phone, and the user may choose to turn the light on or off through the mobile phone's connection through a data network to the smart light bulb. The user simply points their mobile phone at a device they would like to control, the control options for that device are displayed, and the user may control the device through the data network. Advantageously, existing control devices such as mobile phones, tablets, and laptop computers already have the necessary hardware to implement these unique identification and control functions.

### BACKGROUND

1. Field of the Invention

The present invention generally relates to data communication and, more particularly, to the identification of devices for control and automation.

2. Related Art

In the field of data communication, various techniques are used to identify target devices which may be available to be controlled by a controlling device. For example, the Zigbee standard and various other wireless communication standards typically use radio frequency (RF) signals to detect target devices that may be within range of a controlling device.

Unfortunately, such RF signals provide very little or no information on the location of the target device, even though this location information is important to the user of the controlling device. When many target devices are employed in various locations, the problem of identifying these devices to the controlling device of the user is compounded. For example, a user may install numerous “smart light bulbs” in their home which may be controlled by an application on a mobile phone, but the user must first identify and associate each light bulb control with the location of that light bulb. Accordingly, there is a need for a simple, user-friendly method of identifying target devices and their locations.

### SUMMARY

Various techniques are provided to facilitate the identification and location of target devices, such as light bulbs, ceiling fans, and security systems, when such devices are within a visible sight of the controlling device. For example, in one embodiment, a method of performing device identification and location is provided. The method includes detecting a flashing light sequence between a target device and a controlling device. The method also includes a mechanism for allowing the user to select the target device from a list of available target devices for association with the target device's location and capabilities. The slow flashing light from the target device comes from the light bulb itself, in the case of smart light bulbs, or from a status light on the target device. The light signal from the target device is received by the controlling device through an image sensor, such as a camera sensor on a mobile phone, or through a dedicated light sensor on the controlling device. The method further comprises a software application running on the controlling device that provides an image that aids in detecting the location of the target device and a method for the user to select the appropriate target device from a list of available target devices.

In another embodiment, the visible light from a target device is flashed on and off at high speed to provide a data communication mechanism to the controlling device. In this embodiment, the light may switch on and off at speeds higher than the human eye can detect. The method includes the detection of this light sequence by a light sensor on the controlling device and decoding of the data communication by the controlling device. The method also includes a software application running on the controlling device to aid in locating the target device and to display status, parameters, and/or configuration of the target device, allowing the user to select the appropriate target device from a list of available target devices.

In another embodiment, the visible light from a target device is modulated in brightness and/or wavelength at high speed to provide a faster data communication mechanism to the controlling device. In this embodiment, the light may switch on and off at speeds higher than the human eye can detect, as well as change in brightness and/or wavelength, to increase the data speed to the controlling device. The method also includes a software application running on the controlling device to aid in locating the target device and to display status, parameters, and/or configuration of the target device, allowing the user to select the appropriate target device from a list of available target devices.

In another embodiment, the visible light from a target device is modulated by a gateway device, connected to the target device through a wired or wireless network. This method provides for a lower cost target device, since the target device only needs to decode simple commands such as “On” or “Off”, while the gateway device processes complex commands, and where the gateway is able to connect to multiple target devices simultaneously. The gateway sends a series of simple commands to the target device that results in a flashing light sequence from that target device.

### BRIEF DESCRIPTION OF THE FIGURES

FIG. 1 illustrates a target device and a controlling device communicating in accordance with an embodiment of the invention.

FIG. 2 illustrates a high speed light transmission from the target device in accordance with an embodiment of the invention.

FIG. 3 illustrates a high speed light transmission from the target device using amplitude modulation in accordance with an embodiment of the invention.

FIG. 4 illustrates a high speed light transmission from the target device using wavelength modulation in accordance with an embodiment of the invention.

FIG. 5 illustrates a process of identifying the target devices of FIG. 1 on a controlling device in accordance with an embodiment of the invention.

FIG. 6 illustrates a system incorporating a gateway device in accordance with an embodiment of the invention.

Embodiments of the present invention and their advantages are best understood by referring to the detailed description that follows. It should be appreciated that like reference numerals are used to identify like elements illustrated in one or more of the figures.

### DETAILED DESCRIPTION

In accordance with embodiments further described herein, various techniques are provided to identify and locate target devices connected to a wired or wireless network for use by a controlling device on the same network. Advantageously, such techniques may be employed using light sources and light sensors that already exist in the target devices and controlling devices. Another advantage with these techniques is that the line-of-sight communication improves the security of the network between the target and controlling devices, since the communication cannot be performed remotely. However, remote control may be facilitated through the use of a security camera that has line-of-site to the target device, while the control to the security camera may be remote. Finally, these techniques benefit the end-user of these devices, since the target device is easily identified and located visually during the setup process.

For example, in one embodiment, a target device and a control device are connected to a data network allowing for command, control, and status information to be passed between the target device and the control device, but the information on this network does not provide any information as to the location of the target device. The control device is aware of the existence of the target device, but the user of the control device needs to know the location of the target device. Software running on the control device alerts the user to the presence of a target device and the user chooses to begin the identification process. In response to the user input, the control device sends a command to the target device over the data network to begin this identification.

The identification process begins with the target device receiving the command to begin transmitting the identification beacon through its light source. The identification beacon is a slow flashing light that can be seen by the human eye, as well as through the light sensor of the controlling device. For example, if the target device is a light bulb and the control device is a mobile phone, the identification beacon will be a slow flashing on and off of the light bulb, which is detected by the camera sensor on the mobile phone. For other target devices, the identification beacon may be a blinking LED light on the device.

The software application on the control device enables the light sensor, such as a camera sensor on a mobile phone, and tries to detect the flashing light coming from the target device. The user may point the light sensor at the flashing light of the target device to aid in this detection. An image from the light sensor may also be displayed on a screen of the control device to further aid the user in detection.

When the flashing light of the target device is detected by the software of the control device, the user is notified by the control device. The user may then choose to claim this device, give it a name or label, or otherwise acknowledge that the detection is complete. The control device then commands the target device to discontinue the identification beacon, and the identification process is complete.

In another embodiment, the identification beacon is a high speed flashing on and off of the light on the target device. The flashing may be so fast that it is not visible to the human eye, but may still be detected by the light sensor of the target device. Additionally, the flashing may be coded such that it transmits binary data to the control device.

In this embodiment, the user must point the light sensor of the control device at the available target devices, since the user is unable to visually determine which device is sending the identification beacon. The control device tries to detect the high speed flashing light while the user points the sensor at the various target devices.

When the identification beacon of the target device is detected by the control device, the user is notified by the control device in the same manner previously described. Any coded data in the light signal from the target device is decoded by the control device, and such information may be provided to the user. So identified, the user may choose to control the target device in any available manner, such as turning the target device on or off, changing the brightness, or any available control function.

In another embodiment, the identification beacon is a high speed flashing on and off of the light on the target device where each time the light is on the brightness and/or the wavelength of the light is coded to provide greater data throughput.

In this embodiment, the user must point the light sensor of the control device at the available target devices individually, since the user is unable to visually determine which device is sending the identification beacon. The control device tries to detect the high speed flashing light while the user points the sensor at the various target devices.

When the identification beacon of the target device is detected by the control device, the user is notified by the control device in the same manner previously described. Any coded data in the light signal from the target device is decoded by the control device, and such information may be provided to the user. So identified, the user may choose to control the target device in any available manner, such as turning the target device on or off, changing the brightness, or any available control function.

In another embodiment, many target devices may be constantly sending an identification beacon with high speed flashing that is faster than the human eye can detect. Each target device transmits a unique, short coded message using this high speed flashing, which may include amplitude and/or wavelength modulation. This coded message uniquely identifies each target device to a control device. The methods of receiving this message by the control device are the same as has been previously described. The user of the control device may point the light sensor of the control device at any target device, the control device will identify the target device and available control functions of that target device, and the user may optionally select a control function to perform on that target device. The control information for this function is sent to the target device through the data network by the control device. For example, in a home employing multiple smart light bulbs, the user may point the camera on their mobile phone at a particular light bulb, the mobile phone will identify that smart light bulb by its flashing coded message, display the information about that light bulb on the mobile phone screen, and the user may elect to turn the light bulb on or off, change the brightness, or change the color of the light bulb. Upon making this selection, the user's mobile phone sends a command through the wireless data network back to the selected smart light bulb, which performs the function requested.

In another embodiment, the target device is connected to the wired or wireless data network through a gateway device. This gateway device can control the coded flashing sequence of multiple target devices simultaneously by sending simple on/off commands at timed intervals, which eliminates the need for the target device to generate the coded flashing sequence itself, simplifying the hardware, software, and cost of the target device. Additionally, this gateway device processes commands bound for the target device by a control device such that the target device does not need to process certain commands directly and does not need to communicate with the control device directly, also simplifying the hardware, software, and cost of the target device. This gateway may bridge one or more wired or wireless data networks that connect to the control device to one or more wired or wireless data networks that connect to the target device. For example, a mobile phone acting as a control device may be connected to such a gateway through Wifi, while this gateway is also connected to a smart light bulb through Zigbee. When a target light bulb is identified by the mobile phone, the command to turn the light bulb on or off is sent to the gateway, which in turn processes this command and sends an on/off command through Zigbee to the target device. It should be observed that the processing of complex commands in the gateway, as opposed to simple on/off commands, creates a bigger advantage in the cost of the target device, as the processing of multiple target devices can be controlled from a single gateway device.

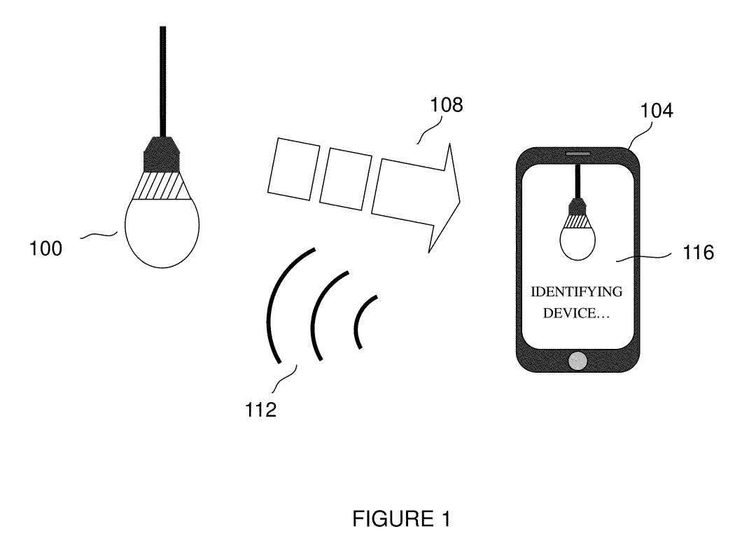

Referring now to the drawings which are provided for purposes of illustrating embodiments of the invention, and not for purposes of limiting the same, FIG. 1 illustrates a smart light bulb 100 transmitting a coded flashing light sequence 108 to a mobile phone 104. Mobile phone 104 displays an image 116 of the smart light bulb 100 on its screen and attempts to identify the smart light bulb device from a list of known devices. The mobile phone 104 transmits wireless signal 112 back to the smart light bulb 100 to provide control information.

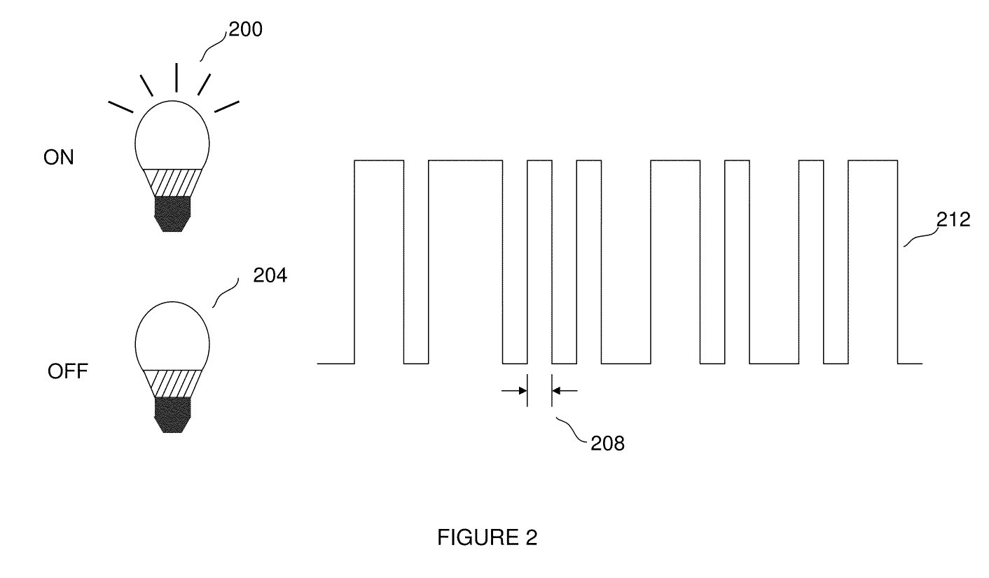

FIGS. 2, 3, and 4 illustrate various embodiments of the coded light transmission from a light source. FIG. 2 graphically illustrates a light transmission 212 that transitions between a light source that is fully ON 200 to a light source that is fully OFF 204 with each bit of information transmit over period 208. For each period 208 that a light is ON 200 may represent a “high” or “1” bit of information, while each period 208 that a light is OFF 204 may represent a “low” or “0” bit of information. The sequence of multiple periods 208 combines to produce coded signal 212, representing identification information about the light source.

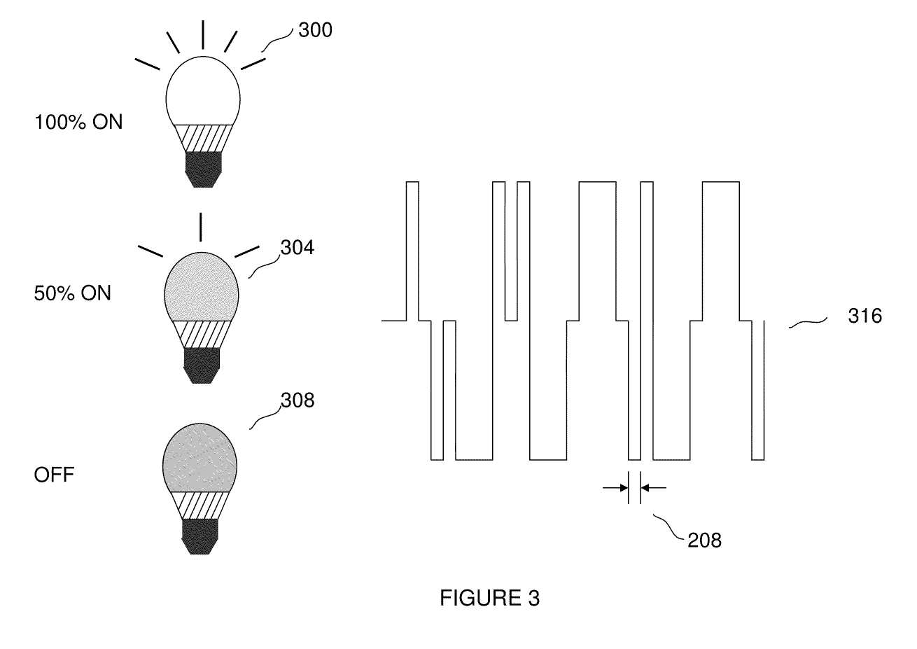

FIG. 3 graphically illustrates a light transmission 316 that transitions between fully ON 300, fully OFF 308, and 50% ON 304 with multiple bits of information transmit over period 208. For each period 208 that a light is fully ON 300 may represent a “1” bit of information, each period 208 that a light is fully OFF 308 may represent a “0” bit of information, and each period 208 that a light is 50% ON 304 may represent a “2” bit of information. The sequence of multiple periods 208 combines to produce coded signal 316, representing identification information about the light source. It should be noted that the invention is not limited to these three light levels, other embodiments may use many different light levels between fully ON 300 and fully OFF 308, with each discrete light level indicating a unique code. Advantageously, the more light levels used result in greater transmission efficiency.

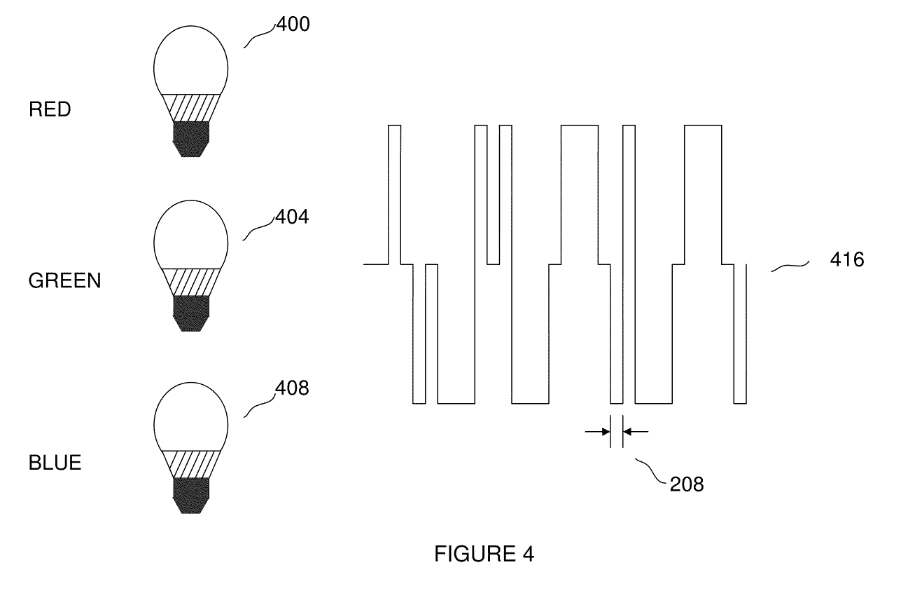

FIG. 4 graphically illustrates a light transmission 416 that transitions between RED 400, GREEN 404, and BLUE 408 colors with multiple bits of information transmit over period 208. For each period 208 that a light is RED 400 may represent a “2” bit of information, each period 208 that a light is GREEN 404 may represent a “1” bit of information, and each period 208 that a light is BLUE may represent a “0” bit of information.

The sequence of multiple periods 208 combines to produce coded signal 416, representing identification information about the light source. It should be noted that the invention is not limited to these three colors, other embodiments may use many different colors that are a mix of RED 400, GREEN 404, and BLUE 408, with each discrete color indicating a unique code. Advantageously, the more colors used result in greater transmission efficiency.

It should be noted that the embodiments of FIG. 3 and FIG. 4 can be combined to produce a light source that modulates both the amplitude of the light from FIG. 3 with the color of the light from FIG. 4 that results in even greater transmission efficiency.

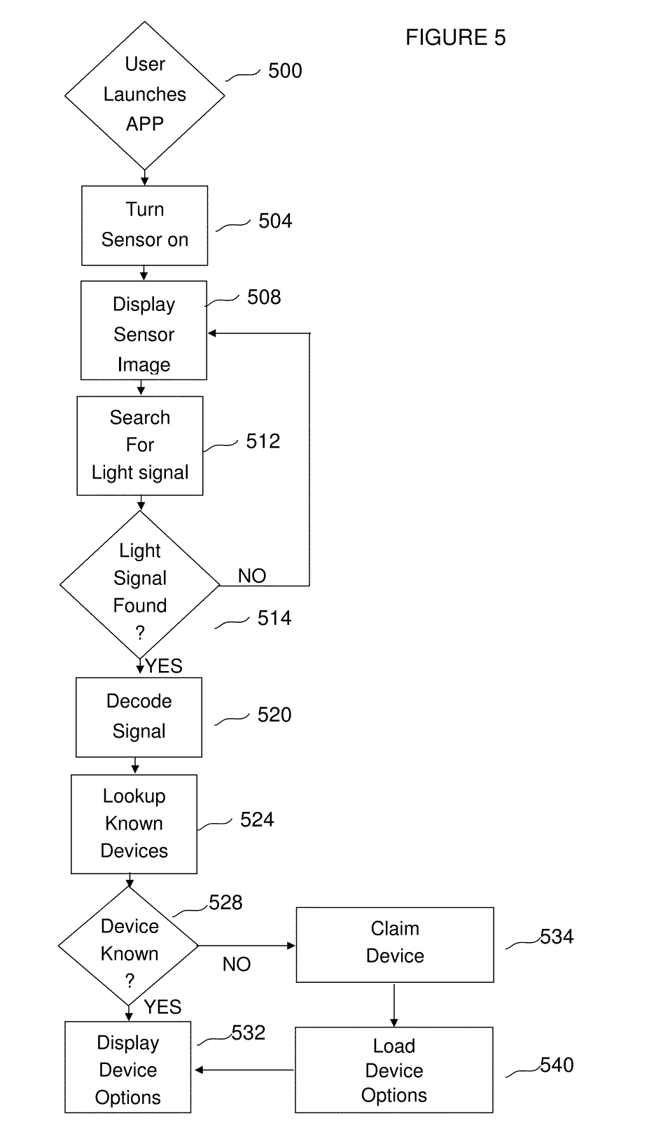

FIG. 5 illustrates the process of device identification by mobile phone 104. First, the user launches the identification application 500 on mobile phone 104. The mobile phone 104 responds by turning on its image or light sensor 504, then displaying the image from the sensor 508 on its display screen 116. Mobile phone 104 then searches the image for a coded light signal 512. If no coded light signal is found 514, then the process returns to update the display image 508 and to search for a coded light signal 512 in a loop until a coded light signal is found. If a coded light signal is discovered 514, then the mobile phone decodes the coded light signal 520 to identify the unique device code. The unique device code is then compared 524 to known device codes. If the device code does not match a previously known device 528, then the user is prompted to claim the device 534. When the user claims the device 534, the mobile phone loads the options available for the device 540 through the wireless network and the device is labeled as “known”. When the device is known, then the user is prompted with a list of options 532. Such options may include turning the device on or off, changing the color of the device, changing the intensity of a device, or if the device has a motor such as a ceiling fan, changing the speed of the device or changing the direction of the device. Different types of devices may have widely varying options for control, and this identification allows the user to see exactly what options are available for that device.

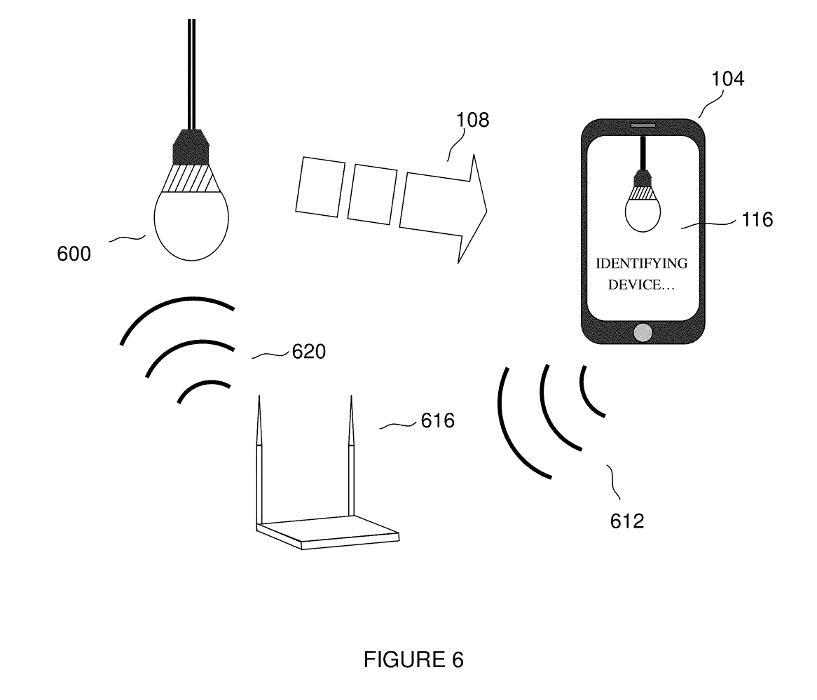

FIG. 6 graphically illustrates an identification and control system similar to FIG. 1, but with the addition of a gateway device 616 used to provide command and control processing of device 600 from control device 104. Smart light bulb 600 transmits a coded flashing light sequence 108 to a mobile phone 104. Mobile phone 104 displays an image 116 of the smart light bulb 100 on its screen and attempts to identify the smart light bulb device from a list of known devices. The mobile phone 104 transmits wireless signal 612 to the gateway device 616 to provide command and control information. Gateway device 616 in turn processes the command and control information from mobile phone 104 and sends commands to the smart light bulb 600 over wireless network 620. It should be noted that wireless network 612 and wireless network 620 may be the same wireless network, or they may be separate networks, separate protocols, and/or separate radio frequencies.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method of performing device identification, the method comprising:
a first target device modulating the brightness and/or wavelength of a built-in light source with a coded message to identify itself;
a first control device detecting the modulated light from the target device through an image sensor or light sensor on the first control device;
the first control device correlating the modulated light sequence of the first target device to decode the coded message identifying the first target device;
the first control device associating the first target device with a list of known target devices on a first data network by using the decoded message from the first target device;
the first control device displaying data about the first target device to a user.

2. The method of claim 1, where the first control device and first target device are connected through a first data network to allow for the exchange of commands, status, and control information between the first target device and the first control device.

3. The method of claim 2, where the first control device displays an image of the target device on a display screen.

4. The method of claim 3, where the first control device displays information about the target device received over the first data network.

5. The method of claim 4, where the first data network is a Wifi network.

6. The method of claim 4, where the first data network is a Zigbee network.

7. The method of claim 4, where the first data network is a Bluetooth network.

8. The method of claim 1, where the first target device is a smart light bulb.

9. The method of claim 1, where the first control device is a mobile phone.

10. A method of performing device identification, the method comprising:
a first gateway device connected to a first target device through a first wired or wireless data network;
a first gateway device sending commands to a first target device to modulate the brightness and/or wavelength of a built-in light source to identify itself;
the first control device correlating the modulated light sequence of the first target device to decode the coded message identifying the first target device;
the first control device associating the first target device with a list of known target devices on a data network by using the decoded message from the first target device;
the first control device displaying data about the first target device to a user.

11. The method of claim 10, where the first control device and first gateway device are connected through a second data network to allow for the exchange of commands, status, and control information between the first target device and the first control device.

12. The method of claim 11, where the first control device displays an image of the target device on a display screen.

13. The method of claim 12, where the first control device displays information about the target device received over the second data network.

14. The method of claim 11, where the second data network is a Wifi network.

15. The method of claim 11, where the second data network is a Zigbee network.

16. The method of claim 11, where the second data network is a Bluetooth network.

17. The method of claim 10, where the first target device is a smart light bulb.

18. The method of claim 10, where the first control device is a mobile phone.

19. A device comprising:
a light source such as an LED;
a controller capable of encoding and modulating the power state of the light source to provide identification information;
and a wireless transceiver for receiving and responding to commands received.

20. The device of claim 19 where the controller is capable of modulating not only the power state of the light source, but also the amplitude and/or the color of the light source to provide identification information.

21. The device of claim 19 where the wireless transceiver is replaced or augmented by a wired transceiver connected to a data network such as Ethernet, Power Line Communication (PLC), Universal Serial Bus (USB), Home Phone Network (HPNA), or other wired protocol.
